(19) United States
(12) Patent Application Publication
(10) Pub. No.: US 2024/0385426 A1
(43) Pub. Date: Nov. 21, 2024

(54) ERECT IMAGE SYSTEM AND LASER RANGING BINOCULARS

(71) Applicant: Shenzhen Valueplus2 Electronics Co., Ltd., Shenzhen City (CN)

(72) Inventor: Conglin SUN, Shenzhen City (CN)

(21) Appl. No.: 18/593,131

(22) Filed: Mar. 1, 2024

(30) Foreign Application Priority Data
May 19, 2023 (CN) 202310570771.3

(51) Int. Cl. G02B 23/02; G01S 7/481; G01S 17/08; G02B 17/08

(52) U.S. Cl. CPC G02B 23/02; G01S 7/481; G01S 17/08; G02B 17/08

(57) ABSTRACT

An erect image system and laser ranging binoculars are provided by the present disclosure, which relate to a technical field of laser ranging binoculars. The erect image system includes a left erect image system and a right erect image system; each of the left erect image system and the right erect image system includes a roof prism and a cemented prism; the cemented prism includes a half pentaprism and a small half pentaprism cemented together; and a cemented surface of the half pentaprisms and the small half pentaprisms is provided with a light-splitting plating film. The present disclosure is not only simple in structure and small in occupied volume, but also convenient to use, and can achieve binocular viewing and aiming, and displaying the distance of the measured object within the field of view in real time when viewing the object.

### CROSS-REFERENCE TO RELATED APPLICATION

This patent application claims the benefit and priority of Chinese Patent Application No. 202310570771.3 filed with the China National Intellectual Property Administration on May 19, 2023, the disclosure of which is incorporated by reference herein in its entirety as part of the present application.

### TECHNICAL FIELD

The present disclosure relates to a technical field of binoculars, in particular to an erect image system and laser ranging binoculars.

### BACKGROUND

Binoculars are already common consumer products, and the laser ranging binoculars are also common functional products on the market. However, regarding the laser ranging binoculars on the market, the ranging binoculars in U.S. Pat. No. 10,288,735 have a longer total length due to a larger prism volume in the light path, and the ranging binoculars in CN20200341261, which uses a light-splitting prism and ranging optics outside the lens tube for display and ranging, have problems such as high cost and large volume, as well as one telescope being not effectively utilized.

### SUMMARY

The present disclosure intends to provide an erect image system and laser ranging binoculars so that the binoculars have a higher internal integration and a smaller volume.

In order to achieve the above objective, the present disclosure provides the following solutions.

An erect image system, includes a left erect image system and a right erect image system; where each of the left erect image system and the right erect image system includes a roof prism and a cemented prism; the cemented prism includes a half pentaprism and a small half pentaprism cemented together; and a cemented surface of the half pentaprism and the small half pentaprisms is provided with a light-splitting plating film;
the roof prism includes a roof transceiving surface, a first roof reflecting surface and a second roof reflecting surface; two ends of the roof transceiving surface are respectively connected with an end of the first roof reflecting surface and an end of the second roof reflecting surface, and an other end of the first roof reflecting surface and an other end of the second roof reflecting surface are connected; and
the cemented prism is provided in a reflecting light path of the roof transceiving surface;
an incident light enters the roof prism through the roof transceiving surface, then enters the half pentaprism after being reflected by the first roof reflecting surface, the second roof reflecting surface and the roof transceiving surface sequentially, then enters the small half pentaprism after being reflected by the half pentaprism and then is transmitted and output.

In order to achieve the above objective, the present disclosure also provides an erect image system, which includes a left erect image system and a right erect image system; where each of the left erect image system and the right erect image system includes a roof prism and a cemented prism; the cemented prism comprises a first prism and a second prism cemented together; and a cemented surface of the first prism and the second prism is provided with a light-splitting plating film;
the roof prism includes a roof transceiving surface, a first roof reflecting surface and a second roof reflecting surface, where two ends of the roof transceiving surface are respectively connected with an end of the first roof reflecting surface and an end of the second roof reflecting surface, and an other end of the first roof reflecting surface and an other end of the second roof reflecting surface are connected; and
the cemented prism is provided in a reflecting light path of the roof transceiving surface;
an incident light enters the roof prism through the roof transceiving surface, then enters the cemented prism after being reflected by the first roof reflecting surface, the second roof reflecting surface and the roof transceiving surface sequentially, and then is reflected and output.

The present disclosure also provides laser ranging binoculars, which include a left telescope, a right telescope, and an erect image system; wherein the left telescope and the right telescope are identical in structure, each of the left telescope and the right telescope comprises an objective lens set, an einzel lens and an eyepiece set; the left telescope is further provided with a photoelectric detector and a display screen, and the right telescope is further provided with a laser emitting tube;
a reflecting light of a target object received by the objective lens set of the left telescope passes through the left erect image system and the einzel lens of the left telescope and then is output to the eyepiece set of the left telescope;
a laser emitted from the laser emitting tube passes through the right erect image system and the objective lens set of the right telescope and then is directed toward the target object;
a light path of the laser reflected by the target object and received by the objective lens set of the left telescope enters the photoelectric detector through the left erect image system; and
a light path of the display screen is output through the left erect image system and the einzel lens of the left telescope to the eyepiece set of the left telescope.

In order to achieve the above objective, the present disclosure also provides laser ranging binoculars, which include a left telescope, a right telescope, and an erect image system; where each of the left telescope and the right telescope includes an objective lens set and an eyepiece set; the left telescope is further provided with a photoelectric detector and a display screen, and the right telescope is further provided with a laser emitting tube;
a reflecting light path of a target object received by the objective lens set of the left telescope passes through the left erect image system and the einzel lens of the left telescope and then is output to the eyepiece set of the left telescope;
a laser emitted from the laser emitting tube passes through the right erect image system and the objective lens set of the right telescope and then is directed toward the target object;
a light path of the laser reflected by the target object and received by the objective lens set of the left telescope enters the photoelectric detector through the left erect image system; and
a light path of the display screen is output through the left erect image system and the einzel lens of the left telescope to the eyepiece set of the left telescope.

According to specific embodiments provided by the present disclosure, the technical effects of the present disclosure are as follows.

The present disclosure provides a new erect image system, and based on the erect image system, laser ranging binoculars are designed with transmitting and receiving separated at two sides, which integrates light paths such as transmitting, receiving, and displaying, so that the binoculars has a higher internal utilization rate and integration, and a smaller volume. The present disclosure can realize the conversion of the inverted image observed via the telescope into the erect image while shortening the light path, and can also realize the transmitting, receiving and projection displaying of the laser. And the arrangement of transmitting and receiving separated at two sides can achieve binocular viewing and aiming of the measured object within the field of view, and displaying the distance of the measured object within the field of view in real time when viewing the object.

### BRIEF DESCRIPTION OF THE DRAWINGS

In order to more clearly illustrate embodiments of the present disclosure or technical solutions in the conventional technology, accompanying drawings used in the embodiments will now be described briefly. It is obvious that the drawings in the following description are only some embodiments of the present disclosure, and that those skilled in the art can obtain other drawings from these drawings without involving any inventive effort.

FIG. 1 is a schematic structural view of a right erect image system according to Embodiment One of the present disclosure;

FIG. 2 is a schematic structural view of a left erect image system according to Embodiment One of the present disclosure;

FIG. 3 is a schematic view of a half pentaprism deflecting light according to Embodiment One of the present disclosure;

FIG. 4 is a schematic view of a small half pentaprism deflecting light according to Embodiment One of the present disclosure;

FIG. 5 is a schematic structural view of a left erect image system according to Embodiment Two of the present disclosure;

FIG. 6 is a three-dimensional schematic structural view of the left erect image system according to Embodiment Two of the present disclosure;

FIG. 7 is a schematic view illustrating the deflection of light by the cemented prism according to Embodiment Two of the present disclosure;

FIG. 8 is a schematic structural view of a laser ranging binoculars according to Embodiment Three of the present disclosure;

FIG. 9 is a schematic view showing a position relationship between a reflecting mirror and a projection lens set according to Embodiment Three of the present disclosure;

FIG. 10 is a schematic view showing a 3D position relationship between the reflecting mirror and a projection lens set according to Embodiment Three of the present disclosure; and

FIG. 11 is a schematic view showing a 3D position relationship between the reflecting mirror and a projection lens set according to Embodiment Four of the present disclosure.

### DETAILED DESCRIPTION OF THE EMBODIMENTS

In the following, technical solutions in the embodiments of the present disclosure will be clearly and completely described with reference to the drawings in the embodiments of the present disclosure. Obviously, the described embodiments are only a part of the embodiments of the present disclosure, rather than all the embodiments. Based on the embodiments of the present disclosure, all other embodiments obtained by a person of ordinary skill in the art without involving any inventive effort fall within the scope of the present disclosure.

Based on this, the present disclosure intends to provide an erect image system and laser ranging binoculars so that binoculars has a higher internal integration and a smaller volume.

To further clarify the above objects, features and advantages of the present disclosure, a more particular description of the disclosure will be rendered by reference to the accompanying drawings and specific embodiments thereof.

### Embodiment One

Embodiment One provides an erect image system including a left erect image system and a right erect image system symmetrically arranged. As shown in FIG. 1, each of the left erect image system and the right erect image system includes a roof prism 2 and a cemented prism 3; the cemented prism 3 includes a half pentaprism 31 and a small half pentaprism 32 cemented together, and preferredly, is consisted of a half pentaprism 31 and a small half pentaprism 32 cemented together; and a cemented surface 311 of the half pentaprisms 31 and the small half pentaprisms 32 are provided with a light-splitting plating film, the role of which is mainly to split a telescopic light beam and a ranging beam.

As shown in FIG. 1, the roof prism 2 includes a roof transceiving surface 21, a first roof reflecting surface 22 and a second roof reflecting surface 23. Two ends of the roof transceiving surface 21 are respectively connected with an end of the first roof reflecting surface 22 and an end of the second roof reflecting surface 23, and the other end of the first roof reflecting surface 22 and the other end of the second roof reflecting surface 23 are connected.

The cemented prism 3 is provided in a reflecting light path of the roof transceiving surface 21; the gap between the two prisms is generally 0-8 mm; an incident light enters the roof prism through the roof transceiving surface 21, then enters the half pentaprism 31 after being reflected by the first roof reflecting surface 22, the second roof reflecting surface 23 and the roof transceiving surface 21 sequentially, then enters the small half pentaprism 32 after being reflected by the half pentaprism and then is transmitted and output.

The small half pentaprism 32 includes a first surface, a second surface and a third surface; two ends of the first surface are respectively connected with an end of the second surface and an end of the third surface, an other end of the second surface is connected with an other end of the third surface; and the half pentaprism 31 is cemented with the first surface of the small half pentaprism 32.

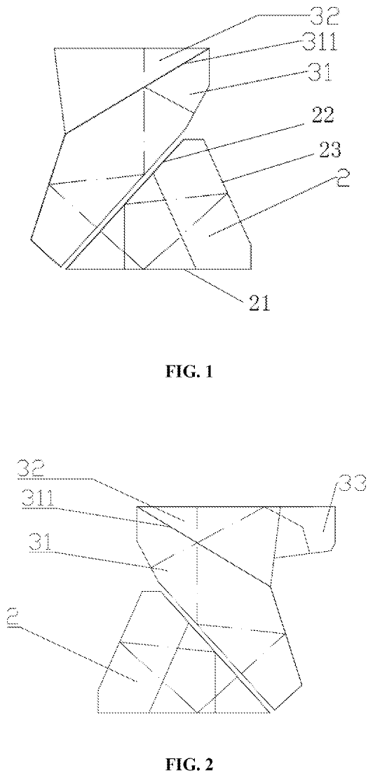

As shown in FIG. 2, the cemented prism 3 in the left erect image system further includes a small cemented prism 33; the small cemented prism 33 is cemented with the third surface of the small half pentaprism 32.

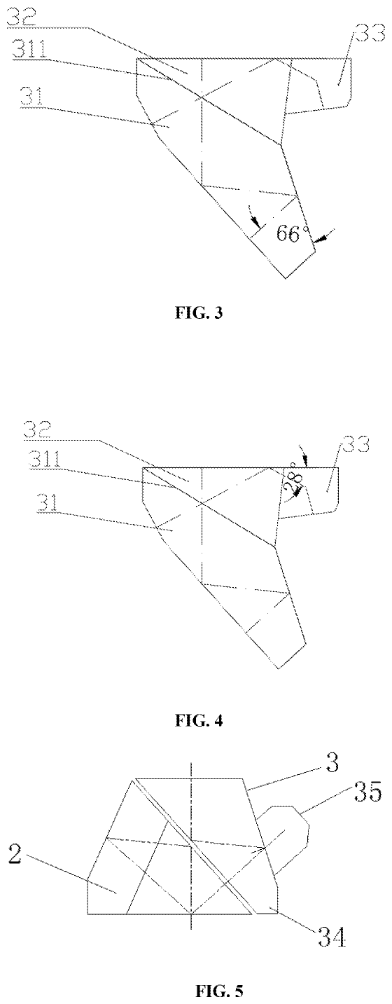

As shown in FIG. 3, the half pentaprism 31 is configured to deflect light, within a deflection angle range of 66±10°, thereby achieving folding of the light, reducing the spatial length and thus the volume of the erect image system.

As shown in FIG. 4, the small half pentaprism 32 is configured to deflect light within the deflection angle range of 28±10°.

### Embodiment Two

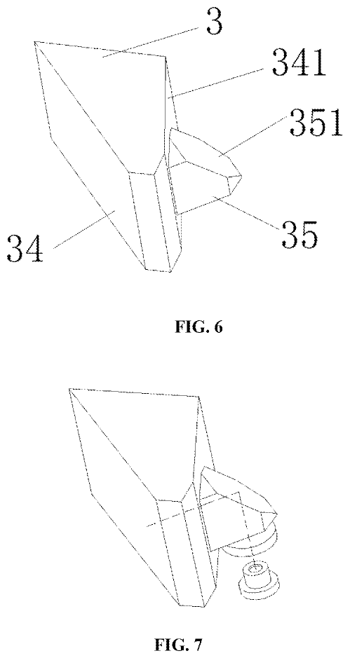

As shown in FIGS. 5-6, different from Embodiment One, in the erect image system provided by Embodiment Two, the cemented prism 3 includes a first prism 34 and a second prism 35 cemented together; and a cemented surface of the first prism 34 and the second prism 35 is provided with a light-splitting plating film. The first prism 34 is configured to deflect light within the deflection angle range of 48±10°. As shown in FIG. 6, the second prism 35 is characterized by having an inclined plane 351, the function of which is to deflect light through the inclined surface, thereby achieving folding of light and thus reducing space length, where the inclined angle is 45±5° relative to the incident angle of the incident light. The incident light enters the roof prism 2 through the roof transceiving surface 21, then enters a cemented prism 3 after being reflected by the first roof reflecting surface 22, the second roof reflecting surface 23 and the roof transceiving surface 21 sequentially, and then is reflected and output.

### Embodiment Three

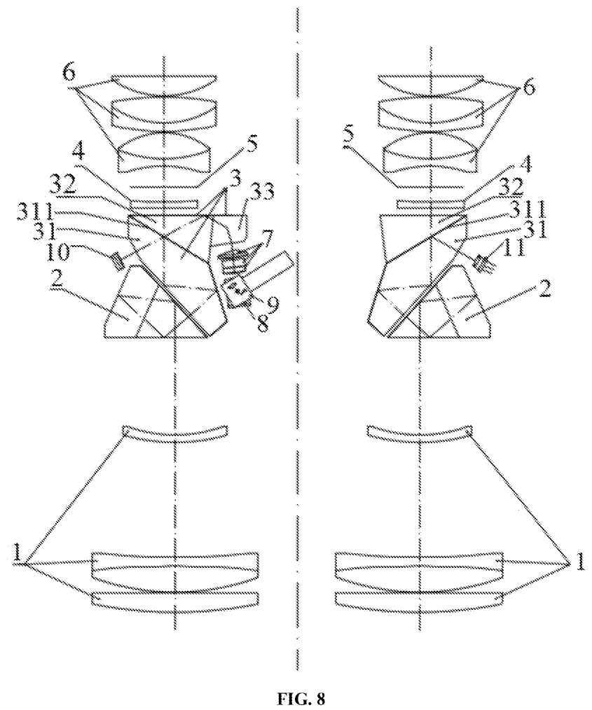

As shown in FIG. 8, this embodiment provides laser ranging binoculars, including: a left telescope, a right telescope, and the left and right erect image systems of Embodiment One. The left telescope and the right telescope are identical in structure, each of the left telescope and the right telescope includes an objective lens set 1, an einzel lens 4 (i.e. a field lens, which can compensate for the field curvature and distortion of the system, and obtain a flat field image plane, etc.) and an eyepiece set 6; the left telescope is further provided with a photoelectric detector 10 and a display screen 9, and the right telescope is further provided with a laser emitting tube 11. The photoelectric detector can also be provided on the right telescope and the laser emitting tube can also be provided on the left telescope.

A reflecting light of a target object received by the objective lens set 1 of the left telescope passes through the left erect image system and the einzel lens 4 of the left telescope and then is output to the eyepiece set 6 of the left telescope.

The light received by the objective lens set 1 enters the roof prism 2 through the roof transceiving surface 21 of the roof prism 2, then enters the half pentaprism 31 after being reflected by the first roof reflecting surface 22, the second roof reflecting surface 23 and the roof transceiving surface 21 sequentially, passes vertically through the einzel lens 4 and enters the eyepiece set 6, thereby achieving binocular viewing and aiming of the target object

The receiving light path shares the objective lens set 1, the roof prism 2 and the half pentaprism 31, and exits from the cemented surface 311 of the half pentaprism 31, where the plating film of the cemented surface 311 is typically characterized by a high transmission of greater than 75% for the visible wavelength region of the human eye, and a high reflectivity of greater than 85% for the corresponding wave band of the ranging laser emitted by the laser emitting tube 11.

A ranging laser emitted from the laser emitting tube 11 passes through the right erect image system and the objective lens set 1 of the right telescope and then is directed toward the target object. The emitting light path shares the objective lens set 1, the roof prism 2 and the half pentaprism 31, and exits from the cemented surface 311 of the half pentaprism 31.

The objective lens set 1 of the left telescope receives a laser echo signal reflected by the target object and the reflected laser enters the photoelectric detector 10 through the left erect image system. The photoelectric detector 10 is located at the focal plane of the objective lens set 1.

The laser emitted from the laser emitting tube 11 enters the objective lens set 1 after being refracted out of the half pentaprism 31 and the roof prism 2 of the right erect image system, and finally directs to the target object through the objective lens set 1. The laser is reflected by the target object and enters the objective lens set 1 of the left telescope, further passes through the roof prism 2 and the half pentaprism 31 of the left erect image system and then enters the photoelectric detector 10, thereby receiving a laser signal. The photoelectric detector 10 calculates the distance of the target object according to the time difference of the emitted laser and the received laser signal by using photoelectric signal processing, and displays the distance on the display screen 9, so that the accurate measurement and display of the distance of the target object is realized.

The light path of the display screen 9 is output through the left erect image system and the einzel lens 4 of the left telescope to the focal plane of the eyepiece set 6 of the left telescope, and the human eyes can clearly see the image information on the display screen 9 through the eyepiece set 6.

Furthermore, the objective lens set 1 includes a lens set composed of multiple lenses and a focusing lens capable of moving along an optical axis. The lenses in the objective lens set are preferably spherical glass lenses, and may also be aspherical glass lenses, plastic lenses, diffraction lenses, or Fresnel lenses, etc. The objective lens set 1 of this embodiment includes an objective einzel lens, doublet lenses and a focusing lens capable of moving along an optical axis sequentially disposed from top to bottom.

Furthermore, the eyepiece set 6 includes multiple sets of lenses. The lenses in the eyepiece set 6 are preferably spherical glass lenses, and may also be aspherical glass lenses, plastic lenses, diffraction lenses, or Fresnel lenses, etc.

In addition, a field diaphragm 5 is further provided between the einzel lens 4 of the left telescope and the left erect image system.

The reflected light from natural light shining on external scenery enters the left erect image system through the objective lens set 1, and by refracting the light through the left erect image system, the image is finally presented at the field diaphragm 5. An image plane presented by the field diaphragm of the target object becomes an object plane of the eyepiece set 6, and the image plane presented by refraction of the eyepiece set 6 enters the human eye.

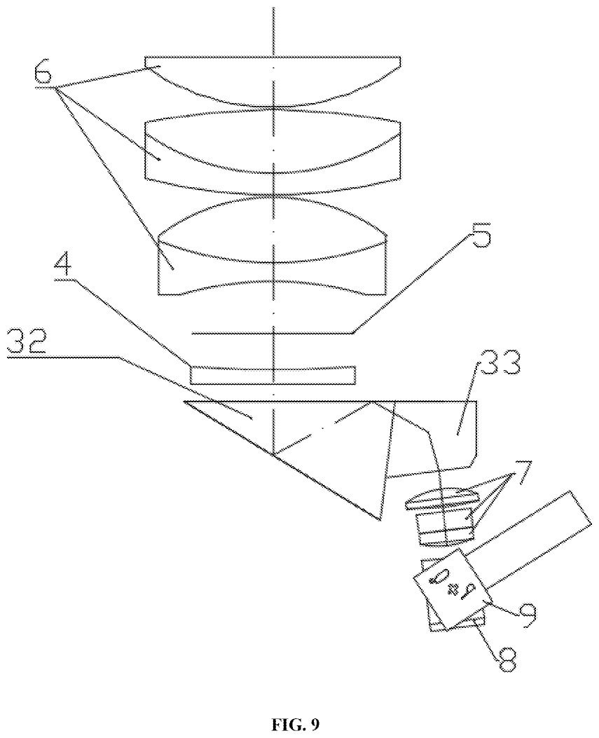

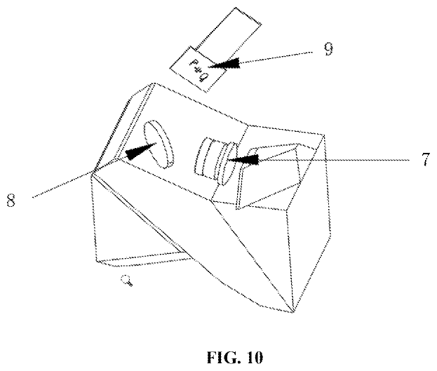

Additionally, as shown in FIGS. 9 and 10, the left telescope further includes a reflecting mirror 8 and a projection lens set 7. As shown in FIG. 9, the reflecting mirror 8 is provided at a right angle formed by the display screen 9 and the projection lens set 7, and the projection lens set 7 is provided between the left erect image system and the display screen 9.

Distance information of the target object is shown on the display screen 9, and the information pattern on the display screen 9 is projected near the field diaphragm 5 via the reflecting mirror 8, the projection lens set 7 and the small cemented prism 33, so that the information pattern projected on the display screen 9 can be viewed directly by the human eye on the eyepiece set 6, achieving real-time viewing and distance measurement of distant objects.

In one embodiment, the display screen 9 opts a light emitting display screen with a design pattern display thereon, and the pattern content includes a distance ranging display and a pattern such as an aiming aid cross or circle.

The projection lens set 7 consists of multiple lenses, the function of which is to project the content shown by the display screen 9. The lenses are preferably spherical glass lenses, and may also be aspherical glass lenses, plastic lenses, diffraction lenses, or Fresnel lenses, etc.

### Embodiment Four

Different from Embodiment Three, laser ranging binoculars provided by this embodiment include: a left telescope, a right telescope, and the erect image system provided by Embodiment Two; where each of the left telescope and the right telescope comprises an objective lens set and an eyepiece set; the left telescope is further provided with a photoelectric detector 10 and a display screen 9, and the right telescope is further provided with a laser emitting tube 11; and the photoelectric detector can also be provided on the right telescope and the laser emitting tube can also be provided on the left telescope.

The reflecting light of a target object received by the objective lens set 1 of the left telescope passes through the left erect image system and then is output to the eyepiece set 6 of the left telescope.

The receiving light path shares the objective lens set 1, the roof prism 2 and the cemented prism 3, and the emitting light path exits from the cemented surface 341 of the first prism 34, where the plating film of the cemented surface 341 is characterized with a high transmission of greater than 75% for the visible wavelength region of the human eye, and a high reflectivity of greater than 85% for the corresponding wave band of the ranging laser emitted by the laser emitting tube 11.

The laser emitted from the laser emitting tube 11 passes through the right erect image system and the objective lens set 1 of the right telescope and then is directed toward the target object; and the emitting light path shares the objective lens set 1, the roof prism 2 and the first prism 34, and exits from the cemented surface 341 of the first prism 34.

The light path of the laser reflected by the target object and received by the objective lens set of the left telescope enters the photoelectric detector through the left erect image system. The photoelectric detector 10 is located at the focal plane of the objective lens set 1.

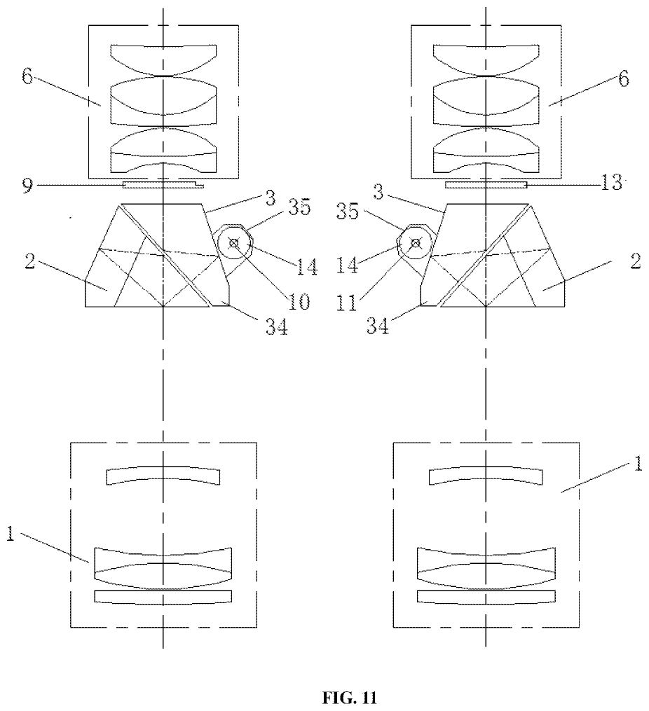

As shown in FIG. 11, the ranging laser emitted from the laser emitting tube 11 enters the objective lens set 1 after being refracted out of the second prism 35, the first prism 34 and the roof prism 2 of the right erect image system, and is finally directed to the target object through the objective lens set 1. The laser is reflected by the target object and enters the objective lens set 1 of the left telescope, further passes through the roof prism 2 and the first prism 34 of the left erect image system and then enters the photoelectric detector 10, thereby receiving a laser signal. The photoelectric detector 10 calculates the distance of the target object by using photoelectric signal processing, according to the time difference of the emitted laser and the received laser signal, and displays the distance on the display screen 9, so that the measurement and display of the distance of the target object is realized.

The light path of the display screen 9 is output through the left erect image system and the left telescope to the focal plane of the eyepiece set 6 of the left telescope, and the human eyes can clearly see the image information on the display screen 9 through the eyepiece set 6. The display screen 9 is preferably a liquid crystal display screen with a high transmission within the visible light wave band, and may also be an OLED (Organic Light Emitting Diode) transmissive display screen, or a combination display of an opaque display screen and a transmissive glass plate. There is a design pattern display on the display screen 9, and the pattern content includes a distance ranging display and a pattern such as an aiming aid cross or circle.

The right telescope is further provided with plate glass 13, the function of which is to balance the brightness of the left and right telescopes and thus improve the user's comfort.

Furthermore, the left telescope and the right telescope are also provided with focusing lenses 14, and adjusting the focusing lenses 14 can make the light-emitting surface of the emitting device located on the focal plane of the emitting optical system and symmetrically located on the left and right. In the same way, adjusting the focusing lenses 14 can make the receiving surface of the receiving device located on the focal plane of the receiving optical system.

The erect image system and the laser ranging binoculars provided by Embodiments One to Four of the present disclosure are not only simple in structure and small in occupied volume, but also convenient to use, and can achieve binocular viewing and aiming of the measured object, and displaying the distance of the measured object within the field of view in real time when viewing the object.

It should be noted that the terms “left” and “right” mentioned in the present disclosure are only for the convenience of illustration and are not limited to the actual left and right. Therefore, the left and right in the actual product are not limited.

The embodiments in the present specification are described in a progressive manner, each embodiment focuses on differences from other embodiments, and the same and similar parts among the embodiments are referred to each other.

The principles and implementation of the present disclosure have been described herein with specific examples, and the above embodiments are presented to aid in the understanding of the methods and core concepts of the present disclosure; meanwhile, those skilled in the art may make some changes in both the detailed description and an application scope according to the teachings of this disclosure. In conclusion, the contents of the description should not be construed as limiting the disclosure.

What is claimed is:

1. An erect image system, comprising: a left erect image system and a right erect image system, wherein each of the left erect image system and the right erect image system comprises a roof prism and a cemented prism; the cemented prism comprises a half pentaprism and a small half pentaprism cemented together; and a cemented surface of the half pentaprisms and the small half pentaprisms is provided with a light-splitting plating film;
the roof prism comprises a roof transceiving surface, a first roof reflecting surface and a second roof reflecting surface, wherein two ends of the roof transceiving surface are respectively connected with an end of the first roof reflecting surface and an end of the second roof reflecting surface, and an other end of the first roof reflecting surface and an other end of the second roof reflecting surface are connected; and
the cemented prism is provided in a reflecting light path of the roof transceiving surface; an incident light enters the roof prism through the roof transceiving surface, then enters the half pentaprism after being reflected by the first roof reflecting surface, the second roof reflecting surface and the roof transceiving surface sequentially, then enters the small half pentaprism after being reflected by the half pentaprism, and then is transmitted and output.

2. The erect image system according to claim 1, wherein the small half pentaprism comprises a first surface, a second surface and a third surface; two ends of the first surface are respectively connected with an end of the second surface and an end of the third surface, an other end of the second surface is connected with an other end of the third surface; and the half pentaprism is cemented with the first surface of the small half pentaprism.

3. The erect image system according to claim 2, wherein the cemented prism in the left erect image system further comprises a small cemented prism; the small cemented prism is cemented with the third surface of the small half pentaprism.

4. An erect image system, comprising: a left erect image system and a right erect image system, wherein each of the left erect image system and the right erect image system comprises a roof prism and a cemented prism; the cemented prism comprises a first prism and a second prism cemented together; and a cemented surface of the first prism and the second prism is provided with a light-splitting plating film;
the roof prism comprises a roof transceiving surface, a first roof reflecting surface and a second roof reflecting surface, wherein two ends of the roof transceiving surface are respectively connected with an end of the first roof reflecting surface and an end of the second roof reflecting surface, and an other end of the first roof reflecting surface and an other end of the second roof reflecting surface are connected; and
the cemented prism is provided in a reflecting light path of the roof transceiving surface; an incident light enters the roof prism through the roof transceiving surface, then enters the cemented prism after being reflected by the first roof reflecting surface, the second roof reflecting surface and the roof transceiving surface sequentially, and then is reflected and output.

5. Laser ranging binoculars, comprising: a left telescope, a right telescope, and the erect image systems of claim 1; wherein the left telescope and the right telescope are identical in structure, each of the left telescope and the right telescope comprises an objective lens set, an einzel lens and an eyepiece set; the left telescope is further provided with a photoelectric detector and a display screen, and the right telescope is further provided with a laser emitting tube;
a reflecting light of a target object received by the objective lens set of the left telescope passes through the left erect image system and the einzel lens of the left telescope and then is output to the eyepiece set of the left telescope;
a laser emitted from the laser emitting tube passes through the right erect image system and the objective lens set of the right telescope and then is directed toward the target object;
a light path of the laser reflected by the target object and received by the objective lens set of the left telescope enters the photoelectric detector through the left erect image system; and
a light path of the display screen is output through the left erect image system and the einzel lens of the left telescope to the eyepiece set of the left telescope.

6. The laser ranging binoculars according to claim 5, wherein the objective lens set comprises an objective einzel lens, an objective cemented lens and an objective compensating lens sequentially disposed from bottom to top.

7. The laser ranging binoculars according to claim 5, wherein the eyepiece set comprises a first eyepiece cemented lens, an eyepiece einzel lens and a second eyepiece cemented lens sequentially disposed from top to bottom.

8. The laser ranging binoculars according to claim 5, wherein the left telescope further comprises a reflecting mirror and a projection lens set; the reflecting mirror is provided at a right angle formed by the display screen and the projection lens set, and the projection lens set is provided between the left erect image system and the display screen.

9. The laser ranging binoculars according to claim 5, wherein the first prism is a half pentaprism, and the second prism is a small half pentaprism; the small half pentaprism comprises a first surface, a second surface and a third surface; two ends of the first surface are respectively connected with an end of the second surface and an end of the third surface, an other end of the second surface is connected with an other end of the third surface; and the half pentaprism is cemented with the first surface of the small half pentaprism.

10. The laser ranging binoculars according to claim 9, wherein the cemented prism in the left erect image system further comprises a small cemented prism; the small cemented prism is cemented with the third surface of the small half pentaprism.

11. Laser ranging binoculars, comprising: a left telescope, a right telescope, and the erect image system of claim 4; wherein each of the left telescope and the right telescope comprises an objective lens set and an eyepiece set; the left telescope is further provided with a photoelectric detector and a display screen, and the right telescope is further provided with a laser emitting tube;
a reflecting light of a target object received by the objective lens set of the left telescope passes through the left erect image system and the einzel lens of the left telescope and then is output to the eyepiece set of the left telescope;
a laser emitted from the laser emitting tube passes through the right erect image system and the objective lens set of the right telescope and then is directed toward the target object;
a light path of the laser reflected by the target object and received by the objective lens set of the left telescope enters the photoelectric detector through the left erect image system; and
a light path of the display screen is output through the left erect image system and the einzel lens of the left telescope to the eyepiece set of the left telescope.

12. The laser ranging binoculars according to claim 11, wherein the right telescope is further provided with plate glass.
